(19) United States
(12) Patent Application Publication
(10) Pub. No.: US 2020/0256366 A1
(43) Pub. Date: Aug. 13, 2020

(54) PIPE JOINING STRUCTURE

(71) Applicant: FUTABA INDUSTRIAL CO., LTD., Okazaki-shi (JP)

(72) Inventor: Fumiki Nagae, Okazaki-shi (JP)

(21) Appl. No.: 16/864,628

(22) Filed: May 1, 2020

Related U.S. Application Data
(63) Continuation of application No. 15/855,236, filed on Dec. 27, 2017.

(30) Foreign Application Priority Data
Jan. 13, 2017 (JP) 2017-004291

(51) Int. Cl. F16B 7/18

(52) U.S. Cl. CPC F16B 7/182

(57) ABSTRACT

Provided is a joining process of two pipes, which can reduce man-hours of the joining process and join the cylindrical pipes together at high accuracy. A first pipe comprises, at an end thereof, an insertion portion having a cylindrical shape to be inserted into a second pipe. The second pipe comprises, at an end thereof, a receiving portion having a tubular shape into which the insertion portion is inserted. A cross sectional shape of at least a hollow portion of the receiving portion, perpendicular to a central axis thereof, is circular. At least one threaded hole is arranged in an area where the receiving portion and the insertion portion overlap each other. The at least one threaded hole penetrates the receiving portion and the insertion portion in a radial direction. A bolt is threadedly engaged in the at least one threaded hole.

### CROSS-REFERENCE TO RELATED APPLICATIONS

This application is a continuation of U.S. patent application Ser. No. 15/855,236 filed on Dec. 27, 2017 and subsequently published as U.S. Patent Application Publication No. 2018/0202477A1 on Jul. 19, 2018, and claims priority to Japanese Patent Application No. 2017-4291 filed on Jan. 13, 2017, wherein the disclosures of the foregoing applications are hereby incorporated by reference herein.

### BACKGROUND

The present disclosure is related to a pipe joining structure.

In a vehicle, a member composed of multiple pipes joined together, for example, such as an instrument panel reinforcement, is used. For joining such pipes, welding is generally performed. Specifically, a known joining method is that a slit (an opening) for welding is arranged at a receiving end of one pipe. An insertion end of another pipe is inserted into the receiving end, and an edge of the slit and the end of the inserted pipe are joined together by arc welding.

Thermal distortion is caused in the pipes by the arc welding, and a shape accuracy after the joining declines. Moreover, since a process of cutting the slit is required, relatively many man-hours are required.

Another joining method is also known, in which polygonal pipes overlap each other, and they are not welded but bolt-joined together (see Japanese Unexamined Patent Application Publication No. 2001-233240).

### SUMMARY

In the joining method disclosed in the aforementioned publication, target pipes of the joining structure are limited to polygonal pipes. Thus, when joining two cylindrical pipes together, it is necessary to process respective edge portions of such pipes so as to each have a polygonal pipe shape. It is also necessary to arrange a nut inside the pipe for fixing a bolt. As a result, man-hours of a joining process inevitably increase.

It is preferable that one aspect of the present disclosure is to provide a pipe joining structure, which can reduce the man-hours of the joining process and join the cylindrical pipes together at high accuracy.

One aspect of the present disclosure is a joining structure of two pipes for use in a vehicle. A first pipe comprises, at an end thereof, an insertion portion having a cylindrical shape to be inserted into a second pipe. The second pipe comprises, at an end thereof, a receiving portion having a tubular shape into which the insertion portion is inserted. A cross sectional shape of at least a hollow portion of the receiving portion, perpendicular to a central axis thereof, is circular. At least one threaded hole is arranged in an area where the receiving portion and the insertion portion overlap each other. The at least one threaded hole penetrates the receiving portion and the insertion portion in a radial direction. A bolt is threadedly engaged in the at least one threaded hole.

In such a configuration, since the pipes are not welded but bolt-joined, it is possible to join the pipes together at high accuracy. Further, since the pipes are joined together in a manner that the bolt is threadedly engaged in the threaded hole penetrating the cylindrical pipes in the radial direction, it is not necessary to process edge portions of the two pipes to be joined together, to be polygonal pipes and it is also not necessary to place a nut inside the pipe. As a result, man-hours of the joining process can be reduced.

In one aspect of the present disclosure, a seating portion for the bolt may be located on an outer circumferential surface of the receiving portion and may be a flat surface. In such a configuration, since a positioning accuracy of the bolt can be improved, a shape accuracy and a joining strength after the joining can be enhanced.

In one aspect of the present disclosure, the first pipe and the second pipe may be different from each other in material. Since arc welding cannot be performed for materials different from each other, it is necessary to use materials identical to each other for pipes to be joined together. On the contrary, in the pipe joining structure of the present disclosure, it is possible to use two pipes different from each other in material. In such a manner that the two pipes to be joined together are different from each other in material, a cost of a member having the pipe joining structure of the present disclosure can be reduced and a performance of the member can be enhanced.

In one aspect of the present disclosure, an outer diameter of the joined structure may increase in a direction from the first pipe to the second pipe. In such a configuration, a member having a large diameter portion and a small diameter portion can be obtained at a low cost and in an excellent quality.

### BRIEF DESCRIPTION OF THE DRAWINGS

An example embodiment of the present disclosure will be described hereinafter with reference to the accompanying drawings, in which:

FIG. 1 is a schematic perspective view showing a joining structure according to one embodiment; and

FIG. 2 is a schematic sectional view showing a surface perpendicular to central axes of pipes of the joining structure according to one embodiment.

### DETAILED DESCRIPTION OF THE PREFERRED EMBODIMENTS

### 1. First Embodiment

[1-1. Configuration]

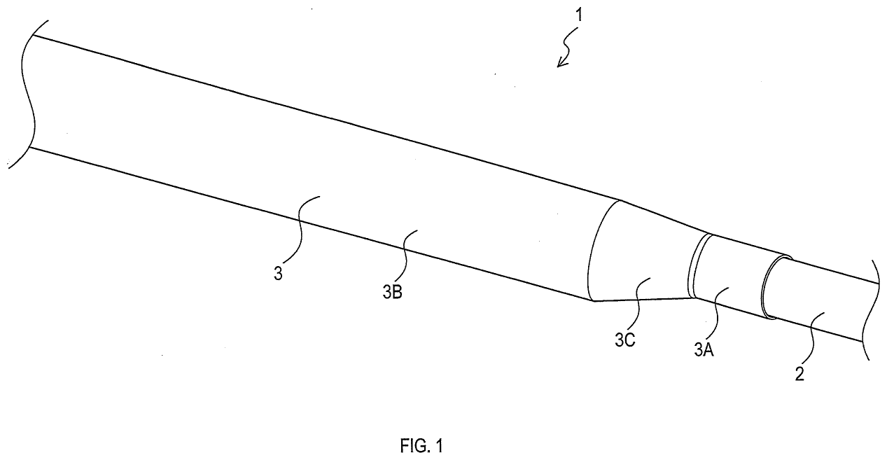

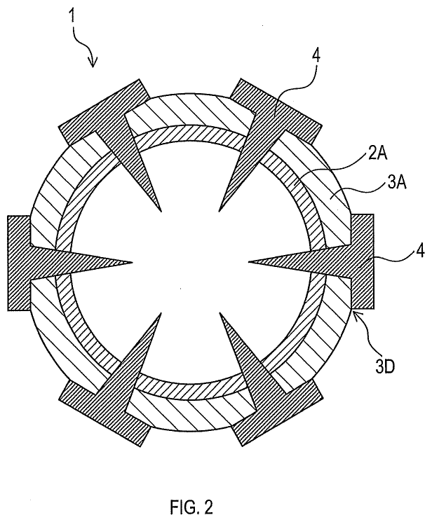

A pipe joining structure (hereinafter, also referred to as a “joining structure”) 1 shown in FIG. 1 and FIG. 2 is a structure for joining two pipes in a member composing a vehicle. The joining structure 1 of the present embodiment is used in an instrument panel reinforcement.

The instrument panel reinforcement is arranged inside an instrument panel and placed along right and left directions of a vehicle (namely, directions perpendicular to front and rear directions of a vehicle) between a driver's seat-side pillar and a passenger's seat-side pillar. The instrument panel reinforcement supports a steering column via members such as a bracket and so forth.

The joining structure 1 in the present embodiment is a structure for joining a small-diameter pipe 2 and a large-diameter pipe 3, which compose the instrument panel reinforcement. The small-diameter pipe 2 corresponds to the first pipe of the two pipes to be joined together and the large-diameter pipe 3 corresponds to the second pipe thereof.

In the joining structure 1 as shown in FIG. 2, penetration of bolts 4 through the small-diameter pipe 2 and the large-diameter pipe 3 in a radial direction (specifically, a thickness direction) joins such pipes together.

<Small-Diameter Pipe>

The small-diameter pipe 2 is a cylindrical straight pipe whose inner diameter and outer diameter are constant along a central axis. The inner diameter and the outer diameter of the small-diameter pipe 2 are smaller than an inner diameter of a receiving portion 3A of the large-diameter pipe 3, which will be described later.

As shown in FIG. 2, the small-diameter pipe 2 comprises, at an end thereof, an insertion portion 2A, which is inserted into the receiving portion 3A of the large-diameter pipe 3. An inner diameter and an outer diameter of the insertion portion 2A are the same as those of the other portions of the small-diameter pipe 2. The insertion portion 2A is inserted into the receiving portion 3A so that central axes of both of the portions are closely aligned with each other.

<Large-Diameter Pipe>

The large-diameter pipe 3 comprises three cylindrical portions whose respective inner diameters and respective outer diameters are different from one another. Specifically, the large-diameter pipe 3 comprises: a receiving portion 3A into which the insertion portion 2A of the small-diameter pipe 2 is inserted; a main body 3B whose inner diameter and outer diameter are larger than those of the receiving portion 3A; and a taper portion 3C coupling the receiving portion 3A and the main body 3B. Thus, the joining structure 1 is configured such that the respective inner diameters and the respective outer diameters of the joined pipes increase in a direction from the small-diameter pipe 2 to the large-diameter pipe 3.

The receiving portion 3A has a circular cross sectional shape, which is perpendicular to a central axis of a hollow portion. The receiving portion 3A is an approximately cylindrical straight pipe-shaped portion whose inner diameter and outer diameter are constant along the central axis. The inner diameter of the receiving portion 3A is the same as (or slightly larger than) the outer diameter of the insertion portion 2A of the small-diameter pipe 2. Specifically, an outer circumferential surface of the insertion portion 2A is in contact with (or almost in contact with) an inner circumferential surface of the receiving portion 3A.

Further, on an outer circumferential surface of the receiving portion 3A, a seating portion 3D for each of the bolts 4 is formed to be a flat surface. In other words, surfaces of the other portions than the seating portions 3D for the bolts 4 on the outer circumferential surface of the receiving portion 3A are curved surfaces, which compose parts of the outer circumferential surface of the cylindrical pipe. The “seating portion” refers to a portion with which a head of the bolt 4 comes in contact.

The main body 3B is a cylindrical straight pipe-shaped portion whose inner diameter and outer diameter are constant along the central axis. The inner diameter and the outer diameter of the main body 3B of the large-diameter pipe 3 are larger than those of the small-diameter pipe 2.

The taper portion 3C couples the main body 3B and the receiving portion 3A, whose outer diameters are different from each other. An outer diameter of the taper portion 3C decreases in a direction from the main body 3B to the receiving portion 3A. The term “taper” herein refers to reducing of a diameter along the central axis and is a concept including a case where an outer rim of a central plane is curved.

<Bolt>

The bolts 4, as shown in FIG. 2, are inserted respectively through threaded holes arranged in an area where the receiving portion 3A and the insertion portion 2A overlap each other. The bolts 4 and the threaded holes penetrate the receiving portion 3A and the insertion portion 2A in the radial direction. In one embodiment, the threaded holes are formed by a threading process performed for holes drilled by rotation friction of a rod-shaped drill.

In the present embodiment, the bolts 4 are inserted as opposing pairs with the central axes of the receiving portion 3A and the insertion portion 2A therebetween. The bolts 4 may be arranged so as to be lined up along the central axes of the receiving portion 3A and the insertion portion 2A, in other words, spaced apart longitudinally. Also, the opposing pairs of the bolts 4 may be aligned longitudinally.

<Material of Pipe>

Materials of the small-diameter pipe 2 and the large-diameter pipe 3 in the joining structure 1 are not particularly limited. The materials that can be used may include metals such as iron, aluminum, or the like, complex materials made of resin and fiber, such as Carbon Fiber Reinforced Plastics (CFRP) or the like, and so forth.

Since no welding is performed in the joining structure 1, it is possible to join pipes whose materials are different from each other. The material of the small-diameter pipe 2 and that of the large-diameter pipe 3 may be the same or they may be different from each other. A combination of different materials for the small-diameter pipe 2 and the large-diameter pipe 3 can expand a selection range of the materials.

One example is iron for the small-diameter pipe 2 and aluminum for the large-diameter pipe 3. With such a combination, a weight of the large-diameter pipe 3 can be reduced, leading to a reduction in a total weight of the instrument panel reinforcement, and a cost of the small-diameter pipe 2 can be reduced. That is, the cost reduction may be sought with a function of the instrument panel reinforcement maintained.

Although the combinations of materials for the small-diameter pipe 2 and the large-diameter pipe 3 are not limited, it is favorable that a material having a higher melting point (for example, iron in a case of a combination of iron and aluminum) is used for a pipe to be placed on an outer side (the large-diameter pipe 3 in the present embodiment). If a material having a higher melting point is placed on an inner side (that is, the pipe to be inserted), a pilot hole drilling before a threaded hole forming step may be required in some cases. However, if the material having a higher melting point is placed on an outer side, such a pilot hole drilling can often be omitted.

<Other Configurations>

In order to facilitate enhancement of a joining strength, in the joining structure 1, the insertion portion 2A of the small-diameter pipe 2 may be press-inserted into the receiving portion 3A of the large-diameter pipe 3.

Further, in the joining structure 1, an adhesive may be applied as a layer between the insertion portion 2A of the small-diameter pipe 2 and the receiving portion 3A of the large-diameter pipe 3. As such an adhesive, a known two-component type or thermosetting adhesive may be used.

By using such methods, the joining strength of the small-diameter pipe 2 and the large-diameter pipe 3 can be enhanced. Consequently, a quality of the instrument panel reinforcement can be improved.

[1-2. Pipe Joining Method]

Hereinafter, a method for producing the joining structure 1, in other words, the pipe joining method will be explained.

The above-described joining method comprises: a flattening step for creating flat surfaces on the outer circumferential surface of the receiving portion 3A of the large-diameter pipe 3; an insertion step for inserting the insertion portion 2A of the small-diameter pipe 2 into the receiving portion 3A; a threaded hole forming step for forming at least one threaded hole on each of the flat surfaces so as to allow the threaded hole to penetrate the receiving portion 3A and the insertion portion 2A in the radial direction; and a threadedly engaging step for threadedly engaging each bolt 4 into a corresponding one of the threaded holes.

(Flattening Step)

In this step, areas on the outer circumferential surface of the cylindrical receiving portion 3A are flattened for drilling the threaded holes therein and the flat surfaces are formed. A known technology can be used for such flattening. For example, multiple divided shaping dies are placed to cover the outer circumferential surface of the receiving portion 3A in the radial direction and pressed to shape the receiving portion 3A. Alternatively, a tubular die is hydraulically squeezed onto the outer circumferential surface of the receiving portion 3A in a pipe insertion direction along the central axis for shaping the receiving portion 3A.

(Insertion Step)

In this step, the insertion portion 2A is inserted into the receiving portion 3A in the pipe insertion direction along the central axis. At this point, the insertion portion 2A may be press-inserted as described above. Further, such insertion may be conducted after an adhesive is applied over the outer circumferential surface of the insertion portion 2A or over the inner circumferential surface of the receiving portion 3A. The insertion portion 2A may be inserted so that an end of the insertion portion 2A goes beyond the receiving portion 3A. Specifically, the insertion portion 2A may be inserted to penetrate some or all of the taper portion 3C of the large-diameter pipe 3.

(Threaded Hole Forming Step)

This step comprises a process of drilling at least one through-hole penetrating the receiving portion 3A and the insertion portion 2A at each of the flat surfaces, and a process of threading the drilled through-holes.

A procedure for drilling the through-hole is conducted as follows. First, for example, a rod-shaped drill (for example, a rotating drilling tool such as “Flowdrill (registered trademark)”) is installed to a rotation axis of a drilling machine. Next, a tip of the drill rotating at high-speed is pressed against the flat surface of the receiving portion 3A, which causes heat due to rotation friction, softens the receiving portion 3A, and drills a hole therein. Then, the drill is further pressed so as to drill a hole in the insertion portion 2A as well, and thus, the through-hole penetrating the receiving portion 3A and the insertion portion 2A is formed.

On the other hand, the drill causes softened areas in the receiving portion 3A and the insertion portion 2A to be plastic flows, and they form portions projecting outwards from circumferences of the through-hole (namely, on an outer side of the radial direction in the receiving portion 3A and on an inner side of the radial direction in the insertion portion 2A). It is preferable that at least one of such projecting portions, which is on the outer side of the radial direction in the receiving portion 3A, is removed by cutting or the like so that the threaded bolt will seat flush with the flat portion. Finally, a conventionally known method can be used for threading the drilled through-hole before inserting a threaded bolt.

(Threadedly Engaging Step)

In this step, the bolts 4 are respectively threadedly engaged in the threaded holes formed, thereby joining the small-diameter pipe 2 and the large-diameter pipe 3 together.

[1-3. Effects]

In the above-described embodiment, the following effects can be obtained.

(1a) Since the joining of the small-diameter pipe 2 and the large-diameter pipe 3 is conducted with the bolts 4 without welding, the pipes can be joined together at high accuracy. Further, since the bolts 4 are threadedly engaged in the threaded holes penetrating the pipes in the radial direction, it is not necessary to process edge portions of the small-diameter pipe 2 and the large-diameter pipe 3 to be polygonal pipes and it is also not necessary to place nuts inside the small-diameter pipe 2. As a result, man-hours of the joining process can be reduced.

(1b) Since the seating portions 3D for the bolts 4 are flattened, a positioning accuracy of the bolt 4 is high. Specifically, drilling into a flat area is more accurate than drilling into a curved area. For this reason, shape accuracies of the small-diameter pipe 2 and the large-diameter pipe 3 after the joining as well as the joining strength can be enhanced.

(1c) Since the small-diameter pipe 2 and the large-diameter pipe 3 can be different from each other in material, with the function and the shape needed for the instrument panel reinforcement maintained, a cost of the joining structure may be reduced.

### 2. Other Embodiments

The embodiment of the present disclosure has been described. However, the present disclosure should not be limited by the aforementioned embodiment, and can be practiced in various manners.

(2a) In the joining structure 1 of the aforementioned embodiment, a shape of a sectional surface, which is perpendicular to a central axis of the receiving portion 3A, for example, may be a polygonal shape such as a hexagon, an octagon, or the like. That is, an outer circumferential surface of the receiving portion 3A may consist of a combination of flat surfaces and may not have any curved surface. If the receiving portion 3A is a polygonal shape, actually in a press process or the like of the flattening step, ridges parallel to the central axis of the receiving portion 3A are formed in respective connecting portions between two of the flat surfaces.

(2b) In the joining structure 1 of the aforementioned embodiment, the seating portions 3D for the bolts 4 may not be necessarily flat surfaces. Specifically, the receiving portion 3 may be a cylindrical pipe where a shape of its cross sectional surface perpendicular to the central axis and a circumference of its hollow portion, both are circular.

(2c) Although the joining structure 1 of the aforementioned embodiment is intended to be used in the instrument panel reinforcement, the joining structure 1 of the aforementioned embodiment is not limited to be used in the instrument panel reinforcement and it can be used in various members of a vehicle.

(2d) In the joining structure 1 of the aforementioned embodiment, a small-diameter pipe and a large-diameter pipe whose inner diameters and outer diameters in respective main bodies of the pipes (in other words, in portions except an insertion portion and a receiving portion) are different from the others, are joined together. However, in the joining structure 1 of the aforementioned embodiment, it is possible to join pipes together, whose diameters are initially identical. In case of joining the same-diameter pipes together, the joining structure of the aforementioned embodiment is applicable when an outer diameter in an insertion portion of an insertion pipe is reduced to be smaller than an inner diameter in a receiving portion of a receiving pipe. Alternately, or simultaneously, the inner diameter in the receiving portion of the receiving pipe is increased to be larger than the inner diameter of the insertion pipe.

(2e) In the joining structure 1 of the aforementioned embodiment, the quantity of the bolts 4 and the quantity of the threaded holes are not limited. A single bolt and a single threaded hole may be used if the receiving portion and the insertion portion can be joined together. However, since it is favorable that the bolts 4 are inserted in opposing pairs so as to be opposed to each other with the central axes of the receiving portion 3A and the insertion portion 2A therebetween, it is favorable that the quantity of the bolts 4 and the quantity of the threaded holes each are an even number, for example, 6 bolts and 6 threaded holes.

(2f) A function/functions performed by one element in the aforementioned embodiments may be performed by a plurality of elements, or a function/functions performed by a plurality of elements may be integrated to be performed by one element. Part of the configuration of the aforementioned embodiments may be omitted. At least part of the configuration of the aforementioned embodiments may be added to or substituted with a configuration of other embodiments described above. Any modes included in the technical ideas specified by the claim language are embodiments of the present disclosure.

What is claimed is:

1. A method for joining two pipes, the method comprising:
inserting an insertion portion of a first pipe into a receiving portion of a second pipe, wherein the insertion portion has a cylindrical shape and is arranged at an end of the first pipe, the receiving portion has a tubular shape and is arranged at an end of the second pipe, and a cross sectional shape of at least a hollow portion of the receiving portion perpendicular to a central axis of the receiving portion is circular;
drilling at least one through-hole in an area where the insertion portion and the receiving portion overlap each other, wherein the at least one through-hole penetrates the receiving portion and the insertion portion in a radial direction continuously from the receiving portion to the insertion portion;
threading the at least one through-hole to form at least one threaded hole; and
threadingly engaging at least one bolt in the at least one threaded hole.

2. The method for joining two pipes according to claim 1, wherein:
an outer circumferential surface of the receiving portion comprises at least one seating portion configured to contact a head of the at least one bolt, and
the at least one seating portion comprises a flat surface.

3. The method for joining two pipes according to claim 1,
wherein the first pipe comprises a material that is compositionally different from a material of the second pipe.

4. The method for joining two pipes according to claim 1,
wherein an outer diameter of a joined pipe formed by the first pipe and the second pipe increases in a direction from the first pipe to the second pipe.

5. The method for joining two pipes according to claim 1,
wherein the threadingly engaging the at least one bolt in the at least one threaded hole comprises threadingly engaging the at least one bolt in the at least one threaded hole to an extent that a tip of the at least one bolt reaches a hollow portion of the first pipe.

6. The method for joining two pipes according to claim 1,
wherein a melting point of the second pipe is higher than a melting point of the first pipe.

7. The method for joining two pipes according to claim 1,
wherein the at least one threaded hole penetrates the receiving portion and the insertion portion in the radial direction.
